(19) United States
(12) Patent Application Publication
(10) Pub. No.: US 2022/0405087 A1
(43) Pub. Date: Dec. 22, 2022

(54) VEHICLE CONTROL DEVICE AND VEHICLE CONTROL SYSTEM

(71) Applicant: HITACHI ASTEMO, LTD., Hitachinaka-shi, Ibaraki (JP)

(72) Inventors: Rumi SOMEYA, Ibaraki (JP); Yusuke KOGURE, Ibaraki (JP); Takaaki NOKAIDO, Ibaraki (JP); Shigeaki MATSUBARA, Ibaraki (JP)

(73) Assignee: HITACHI ASTEMO, LTD., Hitachinaka-shi, Ibaraki (JP)

(21) Appl. No.: 17/777,441

(22) PCT Filed: Dec. 25, 2020
(86) PCT No.: PCT/JP2020/048702

§ 371 Date: May 17, 2022

(30) Foreign Application Priority Data
Mar. 10, 2020 (JP) 2020-041345

(51) Int. Cl. G06F 8/65; G07C 5/08

(52) U.S. Cl. CPC G06F 8/65; G07C 5/0808

(57) ABSTRACT

Provided is a vehicle control device that ensures normal control even when a program including an error is distributed. A vehicle control device includes a calculation unit and a memory, and updates software stored in the memory, and the vehicle control device includes a communication unit which receives encrypted software, a decrypting unit which decrypts the encrypted software into a plaintext, a rewriting unit which is set in the memory and stores the decrypted software, and a determination unit which collates first collation information set in advance in the memory, second collation information given to the software, and the first collation information, determines whether or not to store the decrypted software based on a collation result, and selects the decrypted software as software for next activation when the decrypted software is stored.

### TECHNICAL FIELD

The present invention relates to a vehicle control device and a vehicle control system that update a program by using wireless communication.

### BACKGROUND ART

As one of program update methods for an electronic control unit (ECU) of a vehicle, there is an online update function of downloading a program wirelessly distributed from a program distribution center via a network and updating the program of the ECU.

However, in this program update, an electronic control unit as an update destination and an update program need to be an appropriate combination, and there is a possibility that a vehicle malfunctions or the vehicle does not move in an incorrect combination. For example, there are various combinations of the electronic control unit and the program, and when ECUs of the same model are shared by vehicles having different system configurations, the programs having different configurations can be written to the ECUs, but cannot be processed normally.

As a solution to the above problem, there is a device described in PTL 1 that verifies consistency of a program by a gateway device that transmits the program to a corresponding unit.

### CITATION LIST

### Patent Literature

PTL 1: JP 2017-59210 A

### SUMMARY OF INVENTION

### Technical Problem

The device described in PTL 1 causes the gateway device to execute an update program, confirms that the update program functions correctly in a target ECU, and then transmits the update program to the target ECU.

However, in the online update function of downloading the program wirelessly distributed from the program distribution center via the network and updating the program of the ECU, the program is encrypted and distributed from the viewpoint of security. The encryption can be decrypted only by the update target ECU.

Since the gateway device transmits unit information to the target unit (ECU) while referring to the unit information of a transmission destination, even when the combination of the program encrypted by the program distribution center and the unit information of the transmission destination is erroneously distributed, the program that is not the update target is written in the distributed unit.

Accordingly, when such encryption is necessary, the gateway device cannot decrypt the transmitted program, and thus, there is a problem that it cannot be determined whether or not the transmitted program is an incorrect program.

An object of the present invention is to provide a vehicle control device that ensures normal control by verifying validity of a program by a vehicle control device that has received an encrypted program even when a program including an error is distributed.

### Solution to Problem

The present invention is a vehicle control device which includes a calculation unit and a memory, and updates software stored in the memory. The vehicle control device includes a communication unit which receives encrypted software, a decrypting unit which decrypts the encrypted software into a plaintext, a rewriting unit which is set in the memory and stores the decrypted software, and a determination unit which collates first collation information set in advance in the memory, second collation information given to the software, and the first collation information, determines whether or not to store the decrypted software based on a collation result, and selects the decrypted software as software for next activation when the decrypted software is stored.

### Advantageous Effects of Invention

In the update of the software in the present invention, the validity of the software written in the vehicle control device that is the update target is verified. When incorrect software (program) is distributed, the vehicle control device can prevent the vehicle from malfunctioning or control from becoming unstable due to the incorrect software (program). The reliability of the online software update function can be improved by determining the validity of the update software in the vehicle control device for which the software is to be updated.

Details of at least one implementation of the subject matter disclosed in the present specification are set forth in the accompanying drawings and the following description. Other features, aspects, and effects of the disclosed subject matter will be apparent from the following disclosure, drawings, and claims.

### BRIEF DESCRIPTION OF DRAWINGS

FIG. 1 is a block diagram illustrating an example of a vehicle control device according to a first embodiment of the present invention.

FIG. 2 is a block diagram illustrating an example of a configuration of a vehicle control system according to the first embodiment of the present invention.

FIG. 3 is a diagram illustrating an example of processes performed by a central gateway and an electronic control unit that is an update target in the first embodiment of the present invention.

FIG. 4 is a diagram illustrating an example of distribution of an update program in the first embodiment of the present invention.

FIG. 5A is a first half of a time chart illustrating an example of a process performed by a control system according to the first embodiment of the present invention.

FIG. 5B illustrates a case where a collation result of information stored in a non-rewriting unit is valid in a latter half of the time chart illustrating an example of the process performed by the control system according to the first embodiment of the present invention.

FIG. 6 illustrates a case where a collation result of information stored in a non-rewriting unit is invalid in a latter half of a time chart illustrating an example of a process performed by a control system according to a second embodiment of the present invention.

FIG. 7 illustrates a case where calibration data is distributed in a time chart illustrating an example of a process performed by a control system according to a third embodiment of the present invention.

FIG. 8 illustrates a case where a collation result of calibration data stored in a non-rewriting unit is invalid in a time chart illustrating an example of a process performed by a control system according to a fourth embodiment of the present invention.

FIG. 9 illustrates a case where a collation result of data stored in a data storage region is valid in a time chart illustrating an example of a process performed by a control system according to a fifth embodiment of the present invention.

FIG. 10 illustrates a case where a collation result of data stored in a data storage region is invalid in a time chart illustrating an example of a process performed by a control system according to a sixth embodiment of the present invention.

FIG. 11 illustrates a case where system configuration information is rewritten in a time chart illustrating an example of a process performed by a control system according to a seventh embodiment of the present invention.

FIG. 12 illustrates a case where a collation result of information stored in a fixed data region is valid in a first half of a time chart illustrating an example of a process performed by a control system according to an eighth embodiment of the present invention.

FIG. 13 illustrates a case where the collation result of information stored in the fixed data region is valid in a latter half of the time chart illustrating an example of the process performed by the control system according to the eighth embodiment of the present invention.

FIG. 14 illustrates a case where the collation result of information stored in the fixed data region is invalid in the latter half of the time chart illustrating an example of the process performed by the control system according to the eighth embodiment of the present invention.

FIG. 15A is a first half of a time chart illustrating an example of a process performed by a control system according to a ninth embodiment of the present invention.

FIG. 15B illustrates a case where a collation result of system configuration information is valid in a latter half of the time chart illustrating an example of the process performed by the control system according to the ninth embodiment of the present invention.

FIG. 16 illustrates a case where a collation result of system configuration information is invalid in a time chart illustrating an example of a process performed by a control system according to a tenth embodiment of the present invention.

FIG. 17 is a diagram illustrating an example of an ECU management table according to an eleventh embodiment of the present invention.

FIG. 18 is a diagram illustrating an example of a configuration management table according to a twelfth embodiment of the present invention.

FIG. 19 is a diagram illustrating an example of a collation method according to a thirteenth embodiment of the present invention.

### DESCRIPTION OF EMBODIMENTS

Hereinafter, embodiments of the present invention will be described with reference to the drawings.

### First Embodiment

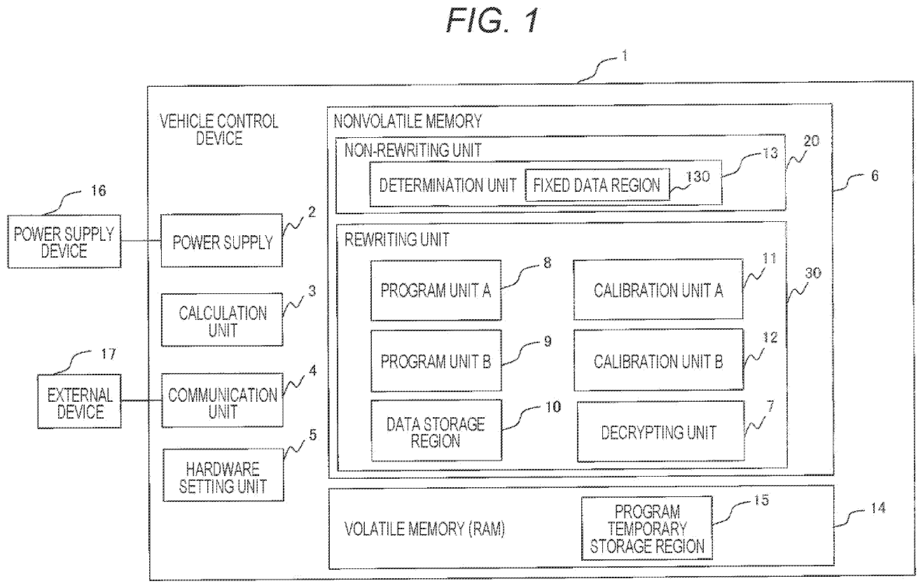

A vehicle control device using an online update function in a first embodiment of the present invention will be described with reference to FIGS. 1 to 5.

FIG. 1 is a block diagram illustrating an example of a configuration of a vehicle control device 1. The vehicle control device 1 is an electronic control unit (ECU), and includes a power supply 2, a calculation unit 3, a communication unit 4, a hardware setting unit 5, a nonvolatile memory 6, and a volatile memory 14.

The volatile memory 14 includes a program temporary storage region 15. The nonvolatile memory 6 includes a non-rewriting unit 20 and a rewriting unit 30. The volatile memory 14 can be a dynamic random access memory (DRAM) or the like, and the nonvolatile memory 6 can be a flash memory or the like.

The non-rewriting unit 20 of the nonvolatile memory 6 stores a determination unit 13 that executes rewriting of software (program or calibration data). The determination unit 13 includes a fixed data region 130 in which data is set in advance.

The rewriting unit 30 of the nonvolatile memory 6 includes a program unit A (8) and a program unit B (9) that store programs for providing the functions of the vehicle control device 1, a calibration unit A (11) and a calibration unit B (12) that store calibration data for adjusting outputs of the programs for providing the functions of the vehicle control device 1, a data storage region 10, and a decrypting unit 7.

One of the program unit A (8) and the program unit B (9) stores an activation program, and the other is used as a standby region. The calibration data used by the activation program is stored in one of the calibration unit A (11) and the calibration unit (12), and the other is used as a standby region.

The data storage region 10 stores configuration information and the like of a control system including the vehicle control device 1. The decrypting unit 7 stores a program for decrypting an encrypted update program, a key, and the like. When a received update program is compressed, the decrypting unit 7 may decompress the received update program.

The volatile memory 14 includes a program temporary storage region 15 that stores the received update program. The update program received by the communication unit 4 is temporarily stored in the program temporary storage region 15 of the volatile memory 14 and is then written in the standby region of the rewriting unit 30.

The power supply 2 receives power supply from a power supply device 16 such as a battery power supply or an accessory (ACC) power supply, and supplies power to each unit of the vehicle control device 1. The calculation unit 3 includes a processor and executes the programs stored in the nonvolatile memory 6 and the volatile memory 14.

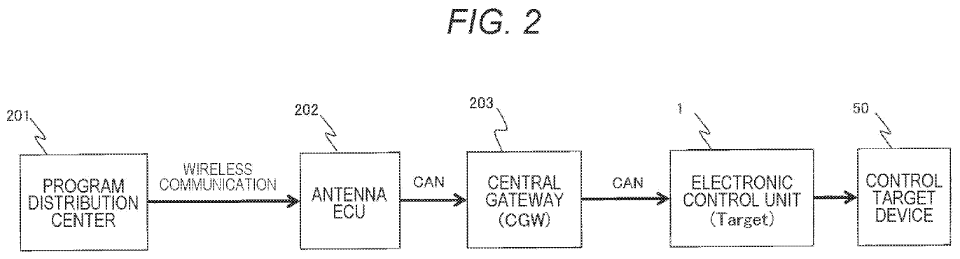

The communication unit 4 communicates with an external device 17 and a control target (see FIG. 2) connected via a controller area network (CAN) or a local area network (LAN). The update program is received from the external device 17 via the communication unit 4. The vehicle control device 1 transmits and receives a control signal necessary for a program update process via the communication unit 4.

The hardware setting unit 5 sets a program to be activated and calibration data in one of the program units A and B and the calibration units A and B. The hardware setting unit 5 may hold the setting for activation in the program unit A (8) and the calibration unit A (11) and may hold the setting for activation in the program unit B (9) and the calibration unit B (12), and thus, the hardware setting unit may be implemented by hardware or software.

Each functional unit of the determination unit 13 and the decrypting unit 7 is executed as the program by the calculation unit 3. The calculation unit 3 operates as a functional unit that provides a predetermined function by executing a process according to the program of each functional unit. For example, the calculation unit 3 functions as the determination unit 13 by executing a process according to a determination program. The same applies to other programs. The calculation unit 3 also operates as functional units that provide functions of a plurality of processes executed by the programs. A computer and a computer system are devices and systems including these functional units.

The vehicle control device 1 realizes a predetermined function according to a program executed by the program unit A (8) or the program unit B (9), and for example, the vehicle control device 1 functions as an automatic driving control unit by activating an automatic driving program.

An example of a form of the external device 17 will be described with reference to FIG. 2. FIG. 2 is a block diagram illustrating an example of a configuration of a control system of a vehicle.

Reference sign 201 in the drawing is a program distribution center that distributes an update program by wireless communication.

The program distribution center 201 stores update programs for all models of the vehicle control device 1 (ECU) that is a service target, service target vehicles, program mounting information of each vehicle, and necessary data regarding other services, and distributes the update program for which a command is accepted.

When an update to a latest version of the program is determined for a certain vehicle in order to improve the performance of the vehicle or the like, the program distribution center 201 distributes a necessary update program to the corresponding vehicle by wireless communication. An antenna ECU (wireless communication unit) 202 of the vehicle receives the distributed information as communication with the host vehicle.

In the drawing, the antenna ECU 202, a central gateway (relay device) 203, the vehicle control device 1, and a control target device 50 are mounted on the vehicle. The control target device 50 includes a controller, an actuator, or another vehicle control device.

The received update program is transferred to the central gateway 203 via a network such as CAN. The central gateway 203 specifies the vehicle control device 1 for which the corresponding update program is to be rewritten among a plurality of vehicle control devices 1 that can communicate with the central gateway 203 by information (header or the like) attached to the information.

The central gateway 203 distributes the update program to the vehicle control device 1 by using the CAN. The vehicle control device 1 that is an update target updates the program by receiving the update program and storing the update program in a region for execution standby.

Since information communication from the program distribution center 201 to the vehicle control device 1 is performed via a CAN that is a type of wireless communication or in-vehicle priority communication in which monitoring and operation from the outside cannot be denied, there is a portion that is not perfect for the safety of the control system.

Thus, in a well-known or known technique, communication contents are encrypted to prevent external intervention. Information is encrypted and decrypted from encryption by using unique information shared only by an encryption device and a decryption device, a so-called encryption key, and thus, confidentiality to the outside is improved.

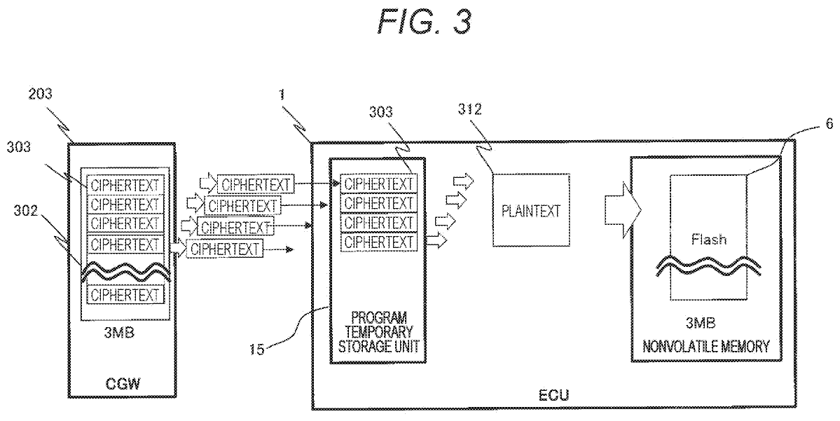

An example of processes performed by the central gateway 203 and the vehicle control device 1 that is the update target will be described with reference to FIG. 3.

The central gateway 203 stores a ciphertext 302 received as the update program for the vehicle control device 1. A size of the update program may be a large capacity that occupies most of the nonvolatile memory 6 in the vehicle control device 1.

Here, the ciphertext 302 is an aggregate of segmented (divided) ciphertexts 303. That is, the ciphertext 302 includes, for example, a plurality of ciphertexts 303 divided into a predetermined size such as a packet or a block. The central gateway 203 transmits the segmented ciphertexts 303 by communication and stores the segmented ciphertexts in the program temporary storage region 15 of the vehicle control device 1.

The decrypting unit 7 of the vehicle control device 1 decrypts the received ciphertext 303 into a plaintext 312 by using unique information (encryption key) of encryption and decryption possessed by the decrypting unit. Subsequently, the vehicle control device 1 writes the decrypted plaintext 312 in a standby region (for example, the program unit A (8)) of the nonvolatile memory 6.

The vehicle control device 1 repeats such a series of processes from when all of the segmented ciphertexts 303 held by the central gateway 203 are received to when writing is completed.

Here, a size of the plaintext 312 to be written in the nonvolatile memory 6 at one time is at least one segmented ciphertext 303, and may be set according to a ratio between the amount of information that can be processed in a unit time by a process of receiving and decrypting one segmented ciphertext 303 and the amount of information that can be processed in a unit time by a process of writing the plaintext 312 in the nonvolatile memory 6.

For example, assuming that the process up to the decryption is four times faster than the process of writing the plaintext 312 in the nonvolatile memory 6, when the four segmented ciphertexts 303 are decrypted into the plaintext and the plaintext is written in the nonvolatile memory 6, the vehicle control device 1 can perform the process up to decryption into the plaintext and the process of writing the plaintext in the nonvolatile memory 6 in parallel, and a required time can be shortened.

When the update process of the program is performed by this method, different contents are repeatedly stored in a region in which the segmented ciphertexts 303 are stored and a region in which the plaintext 312 is stored in the program temporary storage region 15.

Thus, the vehicle control device 1 does not need to store the entire update program at a time, and thus, the vehicle control device can perform rewriting with a capacity sufficiently smaller than a required capacity of the entire program. As a result, a capacity of a storage medium mounted on the vehicle control device 1 can be reduced, and manufacturing cost can be reduced.

Block data that is one of the segmented ciphertexts 303 is transmitted from the central gateway 203 to the vehicle control device 1. The vehicle control device 1 divides a part of the block data in an amount appropriate for decryption of the encryption, and requests the decrypting unit 7 to decrypt the ciphertext 303 together with a decryption process request.

The decrypting unit 7 performs the decryption process on the ciphertext 303 and completes the decryption process on the block data. Here, the example in which the decryption process corresponding to one block data is performed a plurality of times has been described in the present embodiment, but the number of times of decrypting may be an optimum value in consideration of an update processing speed and a memory capacity.

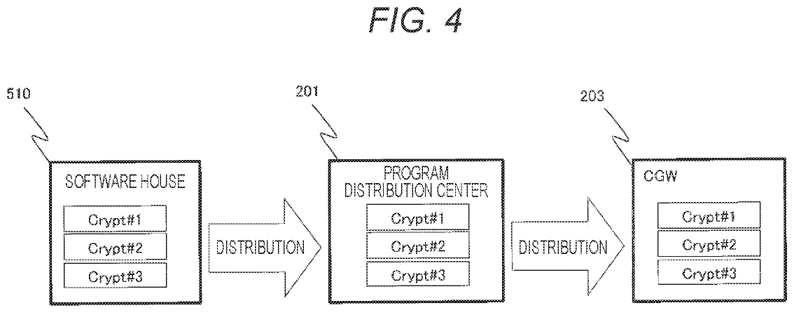

In the description of FIG. 3, it has been described that a group of segmented programs is stored in the central gateway 203 while being divided over the entire program, and an embodiment for realizing the division will be described with reference to FIG. 4. FIG. 4 is a diagram illustrating an example of distribution of the update program.

The update program is stored in the program distribution center 201 as described with reference to FIG. 2. The update program is designed and manufactured in a software house 510. In the software house 510, the entire update program is optimally designed including up to the update process in the vehicle control device 1.

Accordingly, the software house 510 designs an appropriate unit of encryption in consideration of a memory space specification of the vehicle control device 1 as a premise of a series of update processes, a required time for each series of processes and the like. The software house 510 encrypts the update program after dividing the update program according to the design. Unique information of encryption called a common name key is arranged in the non-rewriting unit 20 of the vehicle control device 1 to secure confidentiality.

The update program manufactured by the software house 510 by this method is provided to the program distribution center 201 together with information indicating the vehicle control device 1 that is the update target and information on unrewritten program before being rewritten.

The program distribution center 201 distributes the encrypted update program and the information on the target vehicle control device 1 to an update target vehicle of a program to be separately determined. In the series of processes described above, since the program distribution center 201 does not have an encryption key for the encrypted update program, the program distribution center cannot observe or change the content, and does not perform the observation or change.

Similarly, since the central gateway 203 does not have an encryption key for the encrypted update program, the central gateway cannot observe or change the content or does not perform the observation or change.

With the above process, the encrypted update program manufactured in the software house 510 is distributed to the central gateway 203 and is stored without being changed.

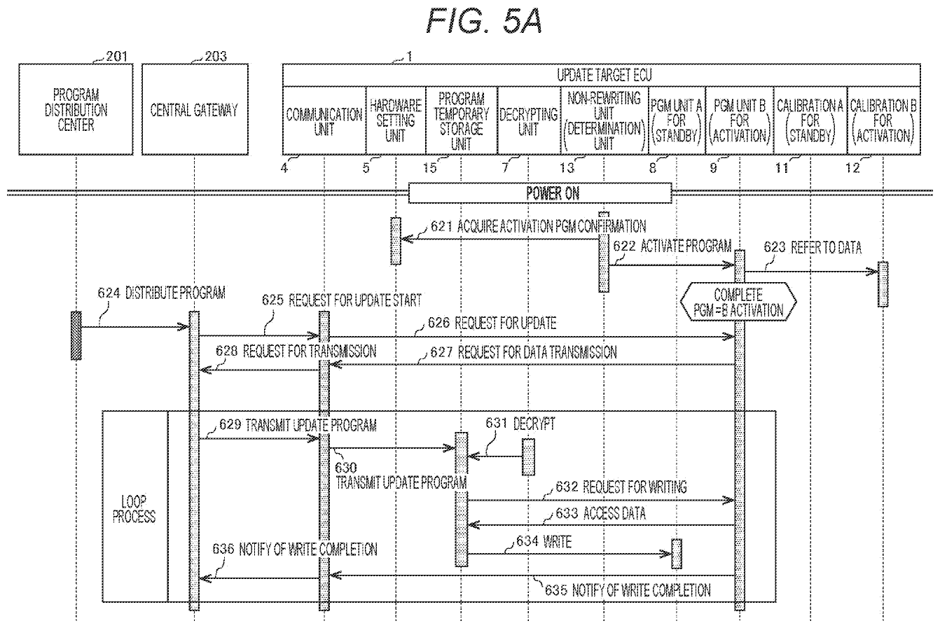

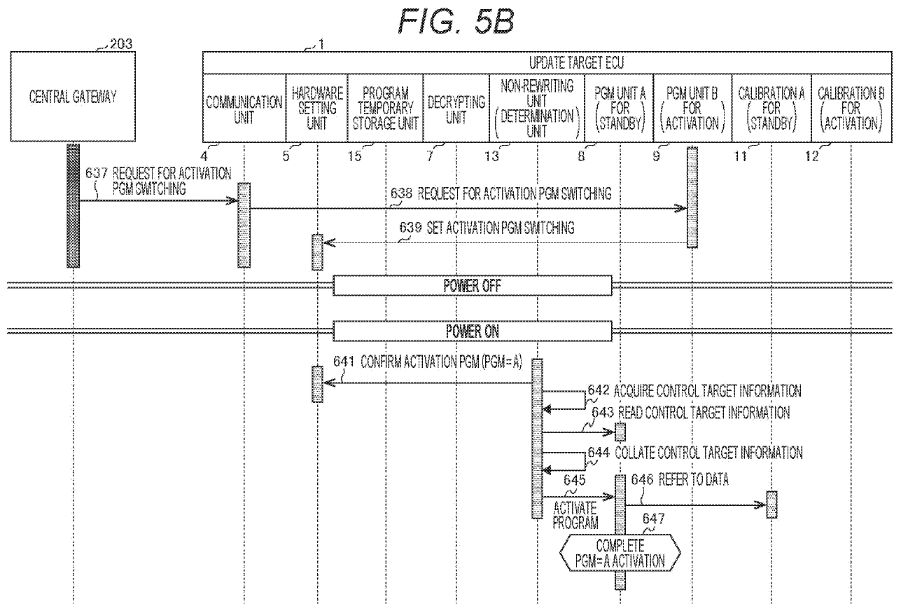

Subsequently, an embodiment of the control system of the present invention will be described with reference to FIGS. 5A and 5B described according to a flow of time. FIG. 5A illustrates a case where a collation result of the information stored in the non-rewriting unit 20 is valid (or matches) in a first half of a time chart illustrating an example of the process performed by the control system. FIG. 5B illustrates a latter half of the time chart illustrating an example of the process performed by the control system.

The illustrated example shows a case where the program unit B (9) is set in advance in the hardware setting unit 5 for activation and control target information is written in the non-rewriting unit 20 at a timing when the vehicle control device 1 is shipped from a factory. The control target information is collation information for determining the validity of the program executed by the vehicle control device 1, and will be described in detail in an eleventh embodiment.

First, the vehicle control device 1 receives power supply (power ON) from an external device (power supply device 12), and activates the determination unit 13 of the non-rewriting unit 20.

The determination unit 13 acquires information on the program unit A (8) or the program unit B (9) for activation set in the hardware setting unit 5 (621). The determination unit 13 activates the program of the rewriting unit 30 corresponding to the set program unit A (8) or program unit B (9) (622). The illustrated example illustrates an example in which the program unit B (9) is used for activation.

The program unit B (9) executes a predetermined process while referring to the calibration data of the calibration unit B (12) corresponding to the program unit B (9) (623). The program unit B (9) continues normal control until the supply to the power supply 2 is cut off (power OFF).

By the above process, the determination unit 13 activates the program from the program unit for activation set in the hardware setting unit 5, performs adjustment with the calibration data, and completes the activation.

When the update program is distributed from the program distribution center 201 (624), the central gateway 203 notifies the currently activated program unit B (9) of an update start request via the communication unit 4 (625 and 626).

The program unit B (9) accepts the update start request of the program, transitions to a reprogramming (program update) mode, and requests the central gateway 203 to transmit data via the communication unit 4 (627 and 628).

As illustrated in FIG. 3, the central gateway 203 that has accepted the transmission request transmits the update program received from the program distribution center 201 as the ciphertext 303 divided into a predetermined size to the vehicle control device 1 that is the update target (629).

Hereinafter, the process of step 629 to 636 is a loop process that is repeatedly executed whenever the vehicle control device 1 receives the ciphertext 303 from the central gateway 203.

Thereafter, in the transmission of the update program in steps 626 and 630, the ciphertext 303 is temporarily stored in the program temporary storage region 15 of the volatile memory 14 from the central gateway 203 via the communication unit 4.

In the transmission process of the update program in steps 629 and 630, the update program is transmitted while being encrypted. In step 631, the decrypting unit 7 holding the encryption key in advance accesses the program temporary storage region 15, decrypts the ciphertext 303, and converts the ciphertext into the plaintext 312.

Among the plurality of ciphertexts 303 constituting the update program, the ciphertext 303 that is a head includes control target information of the update program. The control target information of the update program may be given to the head (header) of the update program in the plaintext.

After the decrypting, the decrypting unit 7 requests the program unit B (9) to write (632). The program unit B (9) accesses the program temporary storage region 15 (633), and writes the decrypted update program in the program unit A (8) set for standby (634). After the writing is ended, the program unit B (9) notifies the central gateway 602 of a writing completion notification via the communication unit 4 (635 and 636).

Step 629 to step 636 of the write completion notification are looped until the writing of the update program distributed from the program distribution center 201 is completed. When all the writing of the update program is completed, the process proceeds to step 637 in FIG. 5B, and the central gateway 203 notifies the program unit B (9) of a switching request of the activation program via the communication unit 4 (637 and 638).

When the switching request of the activation program is accepted, the program unit B (9) switches the activation program set in the hardware setting unit 5 (639).

When the vehicle control device 1 is turned on next time by the switching setting of the activation program of the hardware setting unit 5, the vehicle control device first acquires the activation program from the hardware setting unit 5 in step 641 after the determination unit 13 is activated, and switches to the program unit A (8) in which the update program is written in the illustrated example.

When the program unit A (8) in which the update program is written is activated, the determination unit 13 acquires the control target information written in the non-rewriting unit 20 at the time of factory shipment (642), and reads the control target information described in the program unit A (8) rewritten in the update process (643).

In step 644, the determination unit 13 compares the control target information written in the non-rewriting unit 20 acquired in step 642 with the control target information described in the program unit A (8) read in step 643 (644).

When the determination unit 13 verifies that the two pieces of control target information match, the determination unit activates the update program of the program unit A (8) (645). After the activation of the program, the program unit A (8) performs predetermined adjustment while referring to the calibration data of the calibration unit A (11), and then starts the control of the control target device 50.

Through the above process, the determination unit 13 can determine whether the program to be activated is valid software by verifying that the control target information described in the program unit A (8) for activation set in the hardware setting unit 5 matches the control target information at the time of factory shipment set in the non-rewriting unit 20.

The validity of the program executed by the determination unit 13 is determined, and thus, the reliability of the update process of the program (reprogramming) in the vehicle control device 1 can be improved.

### Second Embodiment

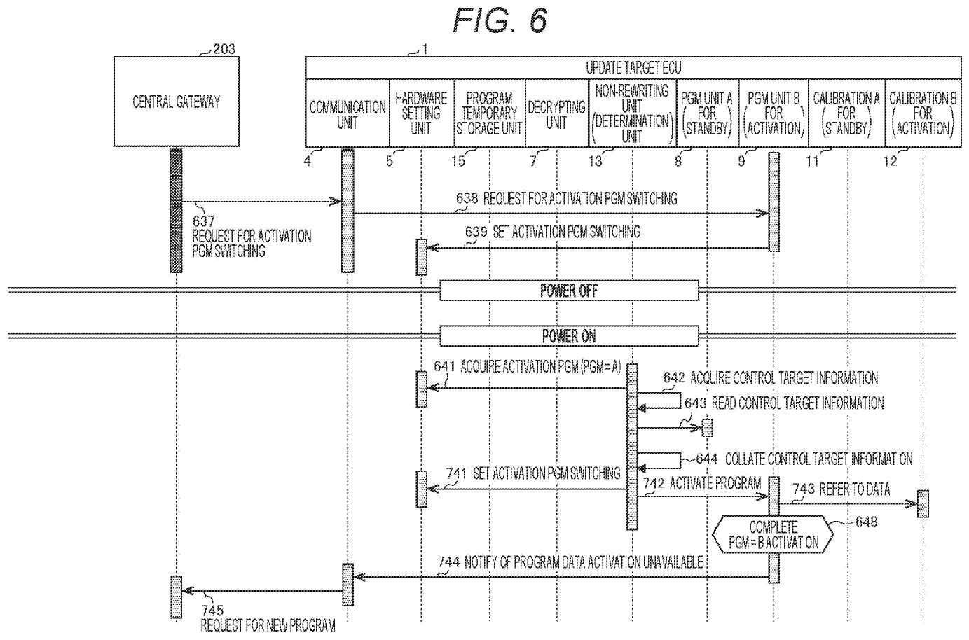

As in the first embodiment, in a second embodiment, an embodiment in which the control target information is written in the non-rewriting unit 20 at a timing when the vehicle control device 1 is shipped from the factory will be described with reference to FIG. 6. FIG. 6 illustrates a case where the collation result of the control target information stored in the non-rewriting unit 20 is invalid (or mismatches) in a latter half of the time chart illustrating the example of the process performed by the control system.

A difference from the first embodiment indicates a case where the collation result does not match in the collation process of the control target information in step 644 in FIG. 5B. The process up to step 644 in the drawing is similar to the process illustrated in FIG. 5B of the first embodiment. Since the processes before step 637 are similar to the processes in FIG. 5A, illustration is omitted. Other configurations are similar to the configurations of the first embodiment.

Upon receiving the power supply (power ON) from the power supply device 16, the vehicle control device 1 activates the determination unit 13 of the non-rewriting unit 20. The processes from the confirmation process (621) of the activation program to the process (643) of reading the control target information are similar to the processes described in the first embodiment.

As in the first embodiment, in step 644, the determination unit 13 collates whether the control target information described in the program unit A (8) for activation set in the hardware setting unit 5 matches the control target information at the time of factory shipment set in the non-rewriting unit 20.

When the collation result does not match, the determination unit 13 accesses the hardware setting unit 5 and performs the switching setting of the activation program (741). In the present embodiment, the determination unit 13 switches the program unit A (8) set in the hardware setting unit 5 to the program unit B (9).

The activation program is switched by the determination unit 13, and thus, it is possible to prevent the occurrence of malfunction due to the control of the vehicle by an incorrect program by prohibiting the activation of the update program written in the program unit A (8).

When the two pieces of control target information do not match, the determination unit 13 activates the program unit B (9) for activation rewritten by the hardware setting unit 5 (742). When the program unit B (9) is activated, the control of the control target device 50 is started while referring to the calibration data of the calibration unit B (12).

The already-activated program unit B (9) notifies the communication unit 4 that the update program (program unit A) cannot be activated (744), and the communication unit 4 requests the central gateway 203 for a new update program (745). Thereafter, the control by the program unit B (9) is continued.

By the above process, whenever the power supply 2 of the vehicle control device 1 is turned on, when the control target information described in the program unit for activation set in the hardware setting unit 5 does not match the control target information at the time of factory shipment set in the non-rewriting unit 20, the determination unit 13 does not activate the standby region in which the update program is written, and activates the program unit in which the update program activated before the power supply is turned off is not written.

When the collation result of the control target information indicates mismatches (is invalid), it is possible to improve the reliability of the update process of the program (reprogramming) in the vehicle control device 1 by prohibiting the activation with the update program. In other words, when the collation result is invalid, it is possible to reliably prevent the vehicle from being controlled by an invalid program by prohibiting the switching between the program units A and B for activation and standby.

The vehicle control device 1 can request a new update program from the central gateway 203 instead of the update program of which the collation result does not match, and can restart the update of the program.

### Third Embodiment

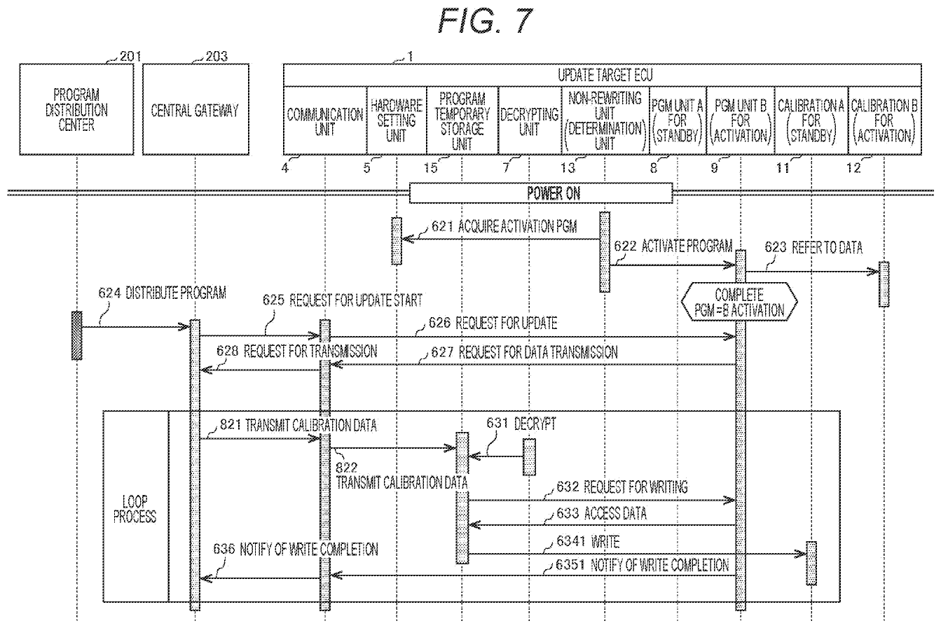

In the first and second embodiments, the data distributed from the program distribution center 201 is the update program, but the distributed data is not limited to the program. In a third embodiment, a write process when the calibration data is distributed from the program distribution center 201 will be described with reference to FIG. 7. FIG. 7 is a time chart illustrating an example of a process performed by the control system, and illustrates a case where the calibration data is distributed. Other configurations are similar to the configurations of the first embodiment.

First, the vehicle control device (ECU) 1 receives power supply (power ON) from the external device (power supply device 12), and activates the determination unit 13 of the non-rewriting unit 20. The processes from the acquisition of the activation program in step 621 to the data transmission request in step 628 are similar to the processes in FIG. 5A of the first embodiment.

In step 624 of the present embodiment, the program distribution center 201 transmits the calibration data to the central gateway 203.

In step 821, the central gateway 602 transmits the calibration data to the communication unit 4 (821). As illustrated in FIG. 3, the central gateway 203 transmits the calibration data as the ciphertext 303 divided into a predetermined size.

Subsequently, the communication unit 4 stores the received ciphertext 303 in the program temporary storage region 15 of the volatile memory 14. Here, similarly to the update program of the first embodiment, in steps 821 and 822, the update program is transmitted while being encrypted.

In step 631, the decrypting unit 7 holding the encryption key accesses the program temporary storage region 15 to decrypt the ciphertext 303.

After the decrypting, the decrypting unit 7 requests the program unit B (9) to write calibration data (632). The program unit B (9) accesses the program temporary storage region 15 (633) and writes the decrypted calibration data in the calibration unit A (11) (6341). After the writing is ended, the program unit B (9) notifies the central gateway 602 of a writing completion notification via the communication unit 4 (6351 and 636).

Step 821 to the writing completion notification in step 636 are looped until the writing of the calibration data distributed from the program distribution center 201 is completed.

The processes after the completion of the writing of the calibration data are similar to the process in a case where the collation result of the first embodiment is normal described with reference to FIG. 5B. The calibration data to be updated may include control target information (collation information), and the collation may be performed similarly to the update program.

As described above, in the vehicle control device 1 of the present embodiment, the program unit A (8) and the calibration unit A (11) set in the rewriting unit 30 can independently rewrite the contents, and the update of the program and the update of the data can be flexibly performed.

The control target information is included in the update program and the calibration data, and thus, it is possible to improve the reliability of the update process.

When a value of the calibration data is changed, since only the value of the calibration data can be updated, it is not necessary to transmit the program and the calibration data together. As a result, it is possible to reduce a processing load at the time of reprogramming and shorten a reprogramming time.

### Fourth Embodiment

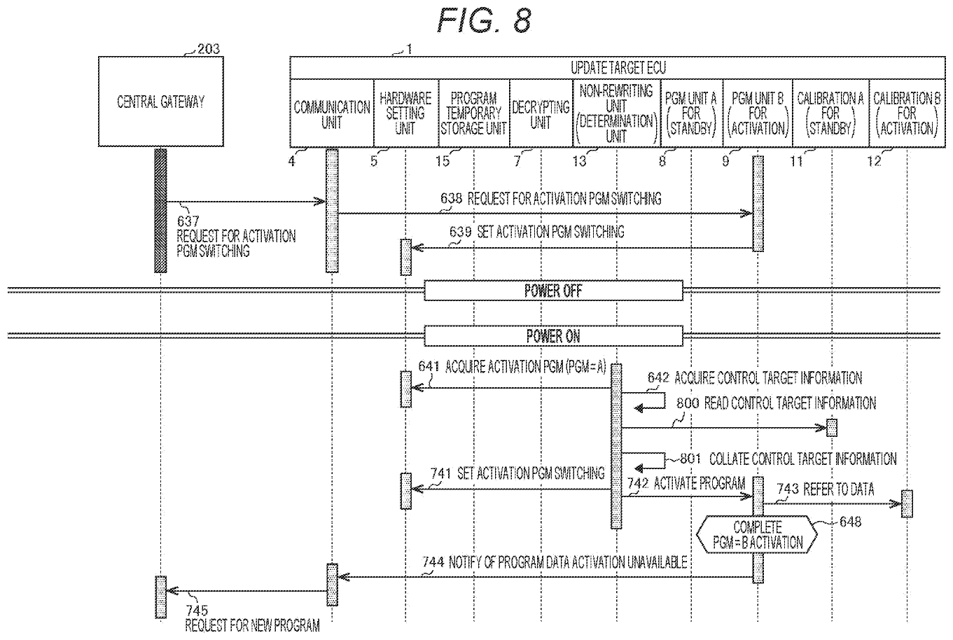

As in the third embodiment, in a fourth embodiment, a write process when the calibration data is distributed will be described. A difference from the third embodiment is a process when the collation result of the control target information does not match. Other configurations are similar to the configurations of the third embodiment. FIG. 8 is a time chart illustrating an example of a process performed by the control system, and illustrates a case where the collation result of the calibration data is invalid (or mismatches).

First, the vehicle control device (ECU) 1 receives power supply (power ON) from the external device (power supply device 12), and activates the determination unit 13 of the non-rewriting unit 20. The processes from the acquisition of the activation program in step 621 to the writing completion notification in step 636 are similar to the processes in FIG. 7 of the third embodiment, and the updated calibration data is stored in the calibration unit A (11). The updated calibration data includes control target information (collation information).

Subsequently, the latter half of the processes is as illustrated in FIG. 8, and the processes from step 637 to step 642 are similar to the processes illustrated in the second embodiment. Upon receiving power supply (power ON) from the external power supply device 12, the vehicle control device 1 activates the determination unit 13 of the non-rewriting unit 20.

The determination unit 13 selects the program unit A (8) from the information set in the hardware setting unit 5 in the acquisition of the activation program in step 641, and reads the control target information (collation information) set at the time of factory shipment from the non-rewriting unit 20 in step 642.

Subsequently, in step 800, the determination unit 13 acquires control target information from the updated calibration data of the calibration unit A (11). In step 801, the determination unit 13 collates the control target information of the non-rewriting unit 20 with the control target information of the calibration data.

When the collation result in step 801 does not match, the determination unit 13 accesses the hardware setting unit 5 and performs switching setting of the activation program (741). This process is similar to the process in a case where the collation result is invalid when the update program is written as described in the second embodiment.

The program to be activated is switched, and thus, the vehicle control device 1 prevents the vehicle from malfunctioning due to the program referring to the incorrect calibration data without referring to the updated calibration data written in the calibration unit A (11).

When the two pieces of control target information do not match, the determination unit 13 activates the program unit B (9) for activation rewritten by the hardware setting unit 5 (742). When the program unit B (9) is activated, the control of the control target device 50 is started while referring to the calibration data of the calibration unit B (12).

The program unit B (9) that has been activated notifies the communication unit 4 that the updated calibration data (calibration unit A) cannot be activated (invalid) (802), and the communication unit 4 requests new calibration data from the central gateway 203 (803). Thereafter, the control by the program unit B (9) is continued.

By the above process, whenever the power supply 2 of the vehicle control device 1 is turned on, when the control target information described in the calibration data used by the activation program set in the hardware setting unit 5 does not match the control target information at the time of factory shipment set in the non-rewriting unit 20, the determination unit 13 does not activate the standby region in which the update calibration has been written, and activates the program unit in which the update program activated before the power supply is turned off has not been written.

As described above, when the collation result of the update calibration data is invalid, the vehicle control device 1 can improve the reliability of reprogramming by prohibiting the activation of the standby program.

### Fifth Embodiment

The first to fourth embodiments show an example in which the control target information is written in the non-rewriting unit 20 at a timing when the vehicle control device 1 is shipped from the factory and the control target information is collated with the control target information stored in the written data.

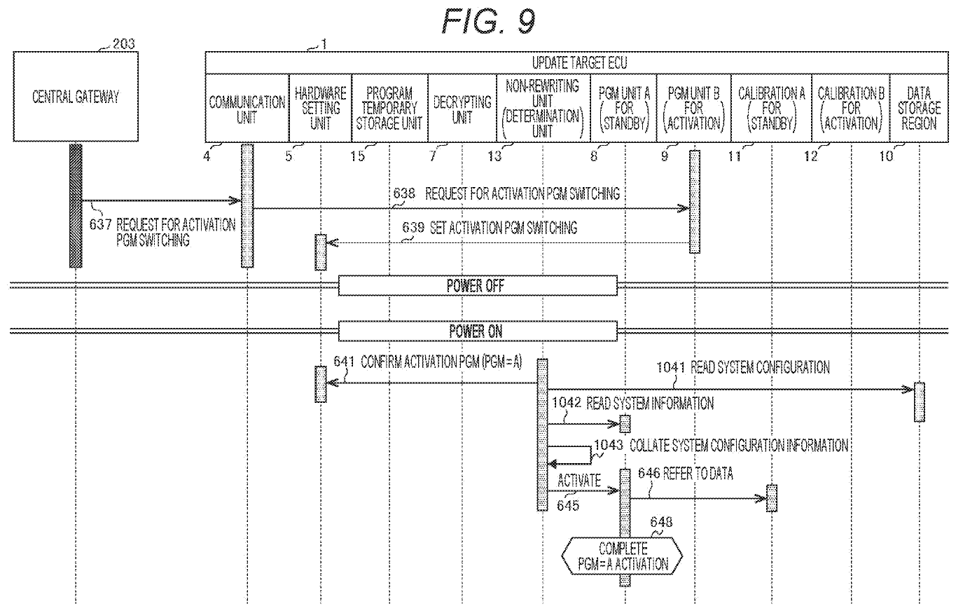

In a fifth embodiment, an example in which the validity of the update program is not collated with the control target information, but system configuration information for each vehicle is stored in the data storage region 10 of the rewriting unit 30, and the collation is performed with the system configuration information when the program is rewritten will be described with reference to FIG. 9. FIG. 9 is a time chart showing an example of a process performed by the control system, and shows a case where a collation result of data stored in the data storage region is valid. The system configuration information will be described in detail in a twelfth embodiment.

A difference from the first embodiment is that the system configuration information stored in the data storage region 10 is collated with system configuration information (system information or an identifier of the control system) included in the program. Since the processes before step 637 in FIG. 9 are similar to the processes in FIG. 5A, illustration is omitted. Other configurations are similar to the configurations of the first embodiment.

Upon receiving the power supply (power ON) from the power supply device 16, the vehicle control device 1 activates the determination unit 13 of the non-rewriting unit 20 and acquires the activation program from the hardware setting unit 5 (641). In the present embodiment, the program unit A is set in the hardware setting unit 5.

In reading the system configuration information in step 1041, the determination unit 13 accesses the data storage region 10 of the rewriting unit 30 and reads the system configuration information.

Thereafter, the determination unit 13 reads the system configuration information stored in the update program of the program unit A (8) in step 1042. In a collation process of the system configuration information in step 1043, the determination unit 13 collates the system configuration information read from the data storage region 10 with the system configuration information read from the program unit A (8).

When the system configuration information read from the data storage region 10 matches the system configuration information written in the program unit A (8), the determination unit 13 activates the program of the program unit A (8) (645).

Similarly to the process of the first embodiment, after the activation of the program unit A (8), the control of the control target device 50 is started while referring to the calibration data stored in the calibration unit A (11) corresponding to the program unit A (8), and the control is performed until the power is turned off.

In the present embodiment, the determination unit 13 collates the validity of the update program with the system configuration information stored in the data storage region 10 of the nonvolatile memory 6. The system configuration information does not need to be stored in the non-rewriting unit 20 at the time of factory shipment, and the collation can be performed even when the collation cannot be performed with the control target information stored in the non-rewriting unit 20.

### Sixth Embodiment

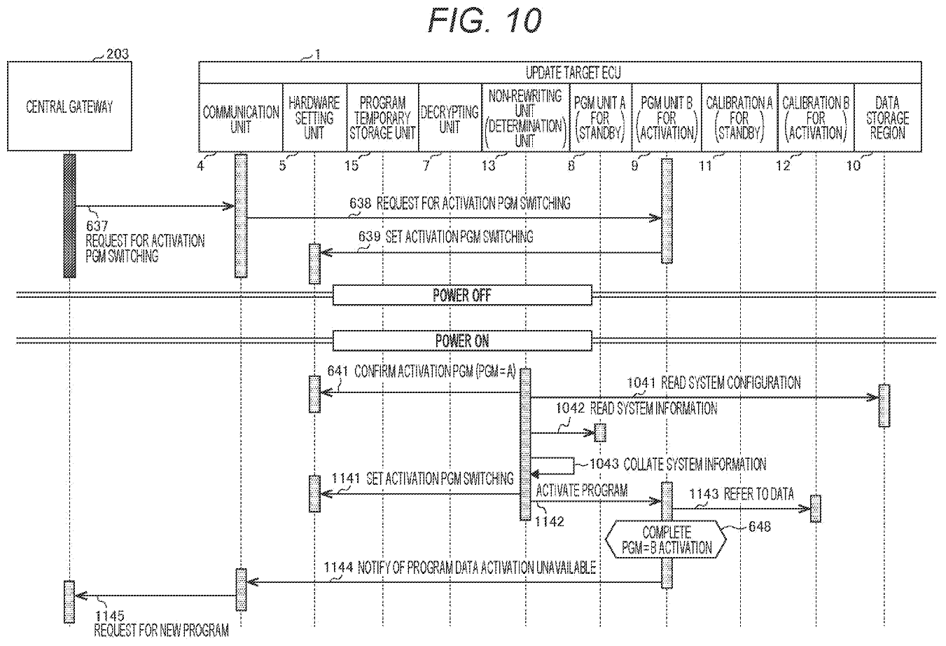

As in the fifth embodiment, in a sixth embodiment, a process of reading the system configuration information of the vehicle stored in the data storage region 10 and collating the system configuration information with the system configuration information stored in the written update program will be described with reference to FIG. 10.

FIG. 10 is a time chart illustrating an example of a process performed by the control system, and illustrates a case where a collation result of data stored in the data storage region is invalid. A difference from the fifth embodiment is a process when the collation result of the system configuration information in step 1043 does not match. Since the processes before step 637 in FIG. 10 are similar to the processes in FIG. 5A, illustration is omitted. Other configurations are similar to the configurations of the fifth embodiment.

Upon receiving the power supply (power ON) from the power supply device 16, the vehicle control device 1 activates the determination unit 13 of the non-rewriting unit 20, and the processes from the process of step 641 of acquiring the activation program from the hardware setting unit 5 to the collation process of the system configuration information of step 1043 are similar to the processes described in the fifth embodiment.

When the collation result is invalid in step 1043, the determination unit 13 does not activate the program unit A (8), and thus, the determination unit switches the activation program stored in the hardware setting unit 5 by the activation program switching setting in step 1141. In the present embodiment, the activation program of the hardware setting unit 5 is switched from the program unit A to the program unit B.

Thereafter, similarly to the processes of FIG. 6 of the second embodiment, the program unit B (9) is activated (1142), and the program unit B (9) starts control while referring to the calibration unit B (12) (1143). The program unit B (9) notifies the communication unit 4 that the collation result is invalid and the update program cannot be activated (1144), and the communication unit 4 requests the central gateway 203 for a new update program (1145).

In the present embodiment, the determination unit 13 collates the validity of the update program with the system configuration information stored in the data storage region 10 of the nonvolatile memory 6, and stops the switching of the program when the collation result is invalid. The system configuration information does not need to be stored in the non-rewriting unit 20 at the time of factory shipment, and the collation can be performed even when the collation cannot be performed with the control target information stored in the non-rewriting unit 20.

Although a rewriting process of the program is described in the fifth and sixth embodiments, it is possible to perform collation by the system configuration information when the calibration data is written as in the third and fourth embodiments.

### Seventh Embodiment

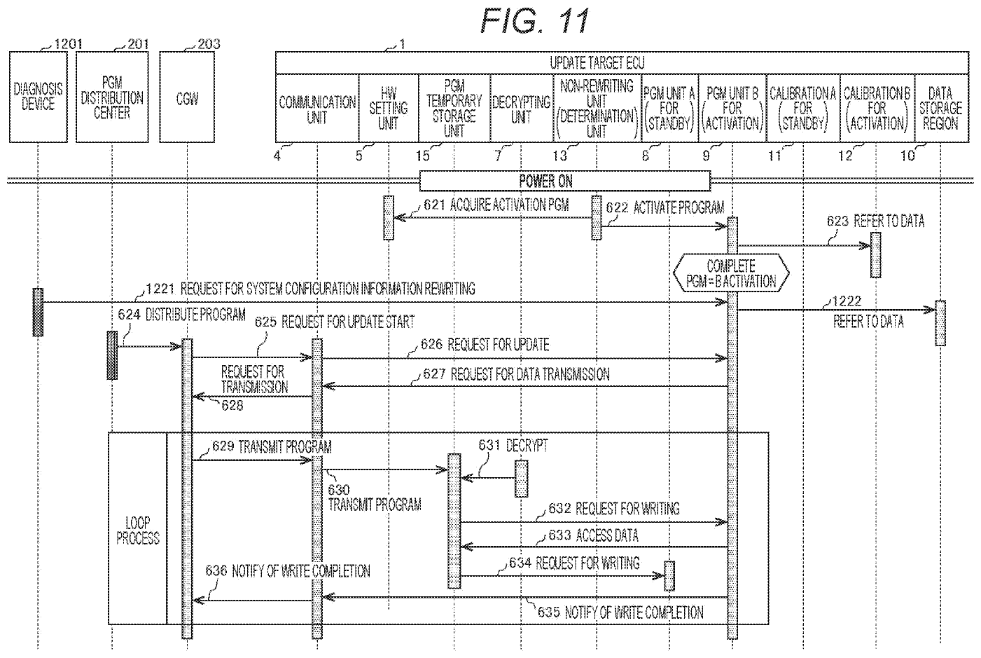

In the fifth and sixth embodiments, the system configuration information of the vehicle stored in the data storage region 10 is read and collated with the system configuration information included in the update program, but the system configuration information can be rewritten from a diagnosis device (consult) 1201 which is the external device 17. A process performed by the vehicle control device 1 collating the system configuration information stored in the written program after the diagnosis device 1201 connected to the vehicle rewrites the system configuration information will be described with reference to FIG. 11. FIG. 11 is a time chart illustrating an example of a process performed by the control system, and illustrates a case where the collation result of the system information is valid after the rewriting of the system configuration information.

Upon receiving the power supply (power ON) from the power supply device 16, the vehicle control device 1 activates the determination unit 13 of the non-rewriting unit 20, acquires the activation program from the hardware setting unit 5 (621), and activates the program unit B (9) (622), and the program unit B (9) starts control while referring to the calibration unit B (12) as in the first embodiment.

After the control of the program unit B (9) is started, the diagnosis device 1201 transmits a request to rewrite the system configuration information in step 1221 in order to rewrite the system configuration information of the vehicle control device 1. The communication unit 4 notifies the program unit B (9) of the received rewrite request.

The program unit B (9) rewrites the system configuration information stored in the data storage region 10 in response to the rewrite request from the diagnosis device 1201.

Thereafter, the processes after the update program is distributed from the program distribution center 201 in step 624 are similar to the processes in claim 1.

As described above, the system configuration information stored in the vehicle control device 1 is also rewritable from the external diagnosis device 1201. Since the system configuration information can be rewritten from the external diagnosis device 1201, the same collation can be performed even when a user of the vehicle optionally changes the components of the control system such as a sensor and a camera or the collation cannot be performed with the control target information written at the time of factory shipment.

### Eighth Embodiment

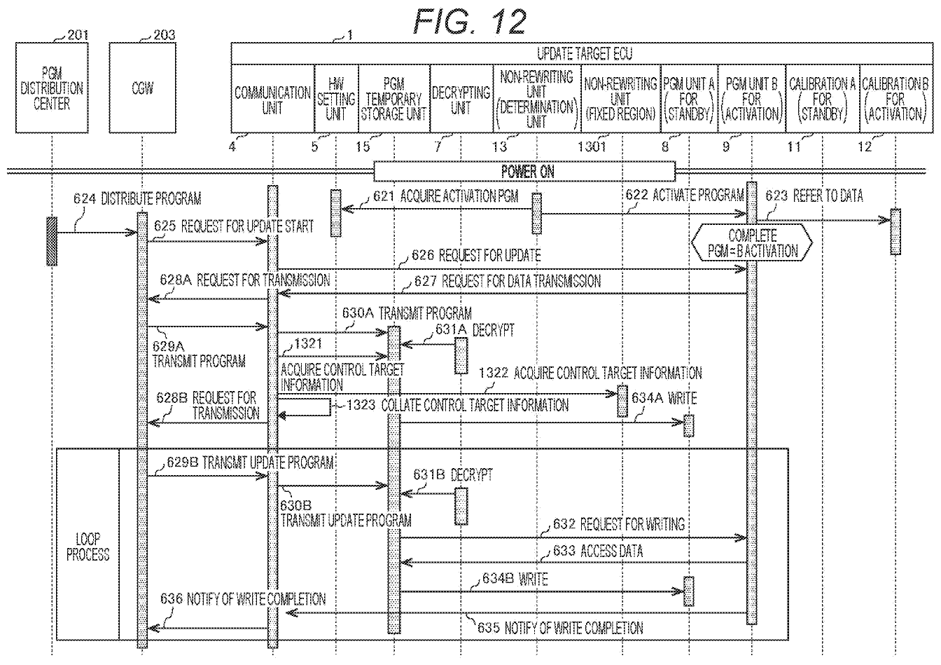

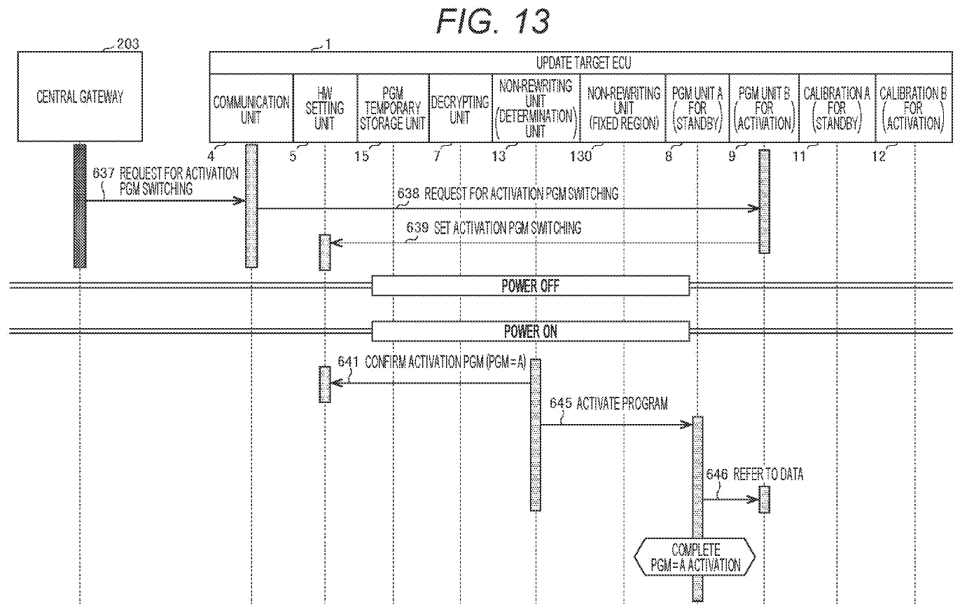

In the first embodiment to the seventh embodiment, the collation of the vehicle control device 1 is performed when the power is turned on again after reprogramming. In the present embodiment, an example in which the vehicle control device 1 collates the control target information before the power is turned off will be described with reference to FIGS. 12 and 13. FIG. 12 illustrates a case where the collation result of the control target information stored in the fixed data region is valid in a first half of the time chart illustrating an example of the process performed by the control system. FIG. 13 is a latter half of a time chart illustrating an example of a process performed by the control system.

A difference from the first embodiment is that the control target information of the vehicle control device 1 is stored in the fixed data region 130 of the non-rewriting unit 20 and the collation is executed before the power is cut off. Other configurations are similar to the configurations of the first embodiment.

Upon receiving the power supply (power ON) from the power supply device 16, the determination unit 13 of the non-rewriting unit 20 is activated, and the processes from the acquisition (621) of the activation program to the data transmission request (627) are similar to the processes in the first embodiment.

In step 628A, the communication unit 4 requests the central gateway 203 for the ciphertext 303 that is the head among the plurality of ciphertexts 303 of the update program. In step 629A, the central gateway 203 transmits the ciphertext 303 that is the head to the communication unit 4. The communication unit 4 stores the ciphertext 303 that is the head in the program temporary storage region 15 (630A).

Subsequently, the decrypting unit 7 decrypts the ciphertext 303 that is the head in the program temporary storage region 15 (631A). The ciphertext 303 that is the head includes the control target information (collation information) of the update program, and the program temporary storage region 15 decrypts a portion of the update program and the control target information.

After the decrypting, in the first embodiment, the communication unit 4 requests the program unit B (9) to write the update program and writes the update program in the program unit A (8). However, in step 1321 of the eighth embodiment, the communication unit 4 acquires control target information of the decrypted update program (plaintext 312) from the program temporary storage region 15.

In step 1322, the communication unit 4 acquires the control target information stored in the fixed data region 130 of the non-rewriting unit 20. Subsequently, the communication unit 4 collates the control target information of the update program with the control target information of the fixed data region 130 (1323).

When the collation result of the control target information is valid, the communication unit 4 starts the write process of the update program.

When the collation result is valid, the communication unit 4 writes the decrypted update program that is the head from the program temporary storage region 15 to the program unit A (8) (634A). The communication unit 4 requests the central gateway 203 to transmit the second and subsequent ciphertexts 303 (628B).

Subsequently, a loop process in steps 629B to 636 is performed, and the second and subsequent ciphertexts 303 are sequentially decrypted and stored in the program unit A (8).

In step 629B, the central gateway 203 sequentially transmits the second and subsequent ciphertexts 303 to the communication unit 4, and in step 630B, the communication unit 4 sequentially stores the second and subsequent ciphertexts 303 in the program temporary storage region 15. In step 631B, the decrypting unit 7 decrypts the ciphertext 303 stored in the program temporary storage region 15.

The communication unit 4 transmits a request to write the second and subsequent update programs decrypted in the program temporary storage region 15 to the program unit B (9). The program unit B (9) accepts the write request, accesses the program temporary storage region 15 (633), and writes a portion of the decrypted update program to the program unit A (8) (634B).

When the writing is completed, the program unit B (9) notifies the communication unit 4 of the completion of the writing (635), and the communication unit 4 notifies the central gateway 203 of the completion of the writing (636).

After the writing of the distributed update program to the program unit A (8) is ended, the communication unit 4 accepts a request to switch the activation program from the central gateway 602 in step 637 illustrated in FIG. 13.

The communication unit 4 requests the program unit B (9) to switch the activation program (638), and the program unit B (9) switches the information on the activation program stored in the hardware setting unit 5 to the program A (8) designated from the central gateway 203 (639).

When the vehicle control device 1 is activated on next time, the determination unit 13 acquires the setting of the activation program from the hardware setting unit 5 in step 641 of FIG. 13, the program unit A (8) is activated in step 645, and the program unit A (8) refers to the calibration data A (11) in step 646.

In the first embodiment, before the program unit A (8) is activated in step 645, the determination unit 13 performs the processes from the acquisition of the control target information in step 642 to the collation in step 644 illustrated in FIG. 5B. On the other hand, in the present embodiment, since the control target information is collated immediately after the decrypting (631A), the collation after the reactivation may not be performed.

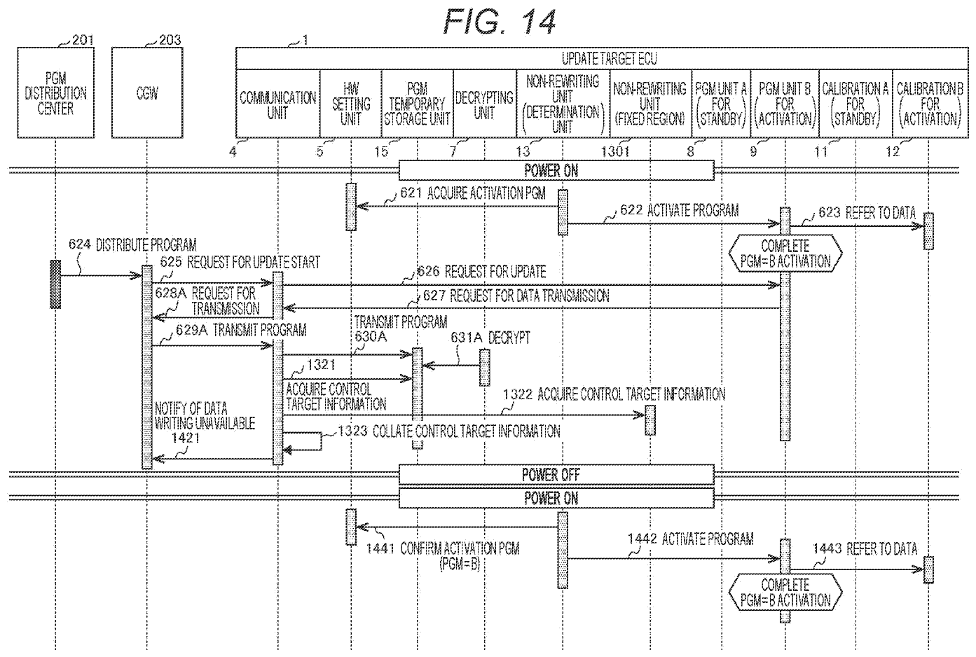

FIG. 14 is a time chart illustrating an example of a process performed by the control system, and illustrates a case where the collation result of the control target information stored in the fixed data region is invalid. The processes from step 621 to step 1322 are similar to the processes in FIG. 12.

Step S1323 is a case where the result of comparison between the control target information acquired from the program temporary storage region 15 and the control target information acquired from the fixed data region 130 by the communication unit 4 is invalid.

In this case, the communication unit 4 does not perform the loop process of steps 632 to 636 in FIG. 12, notifies the central gateway 203 that the update program cannot be written since the collation result is invalid, and ends the update process.

When the vehicle control device 1 is activated on next time, the determination unit 13 acquires the setting of the activation program in step 1441 of FIG. 14, the program unit B (9) is activated in step 1442, and the program unit B (9) refers to the calibration data in step 1443.

In the present embodiment, since the collation is performed immediately after the decrypting (631A), the process of writing the update program in the program unit is stopped when the collation result is invalid, and thus, useless processes can be reduced.

As described above, in the eighth embodiment, the vehicle control device 1 receives the plurality of divided ciphertexts 303, and the determination unit (13) acquires control target information 218 included in the first received ciphertext 303 among the divided ciphertexts 303 and collates the control target information with control target information 211.

As a result, since the collation of the pieces of control target information (211 and 218) is performed at a stage before the decrypted update program is written in the rewriting unit 30, it is possible to improve the reliability of the update process of the program (reprogramming) in the vehicle control device 1 as in the first embodiment.

### Ninth Embodiment

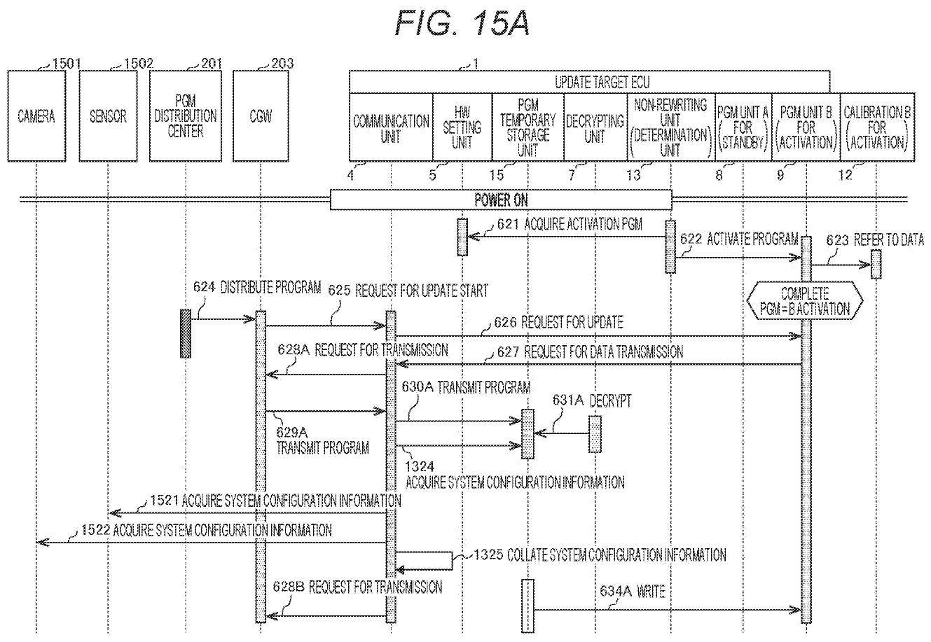

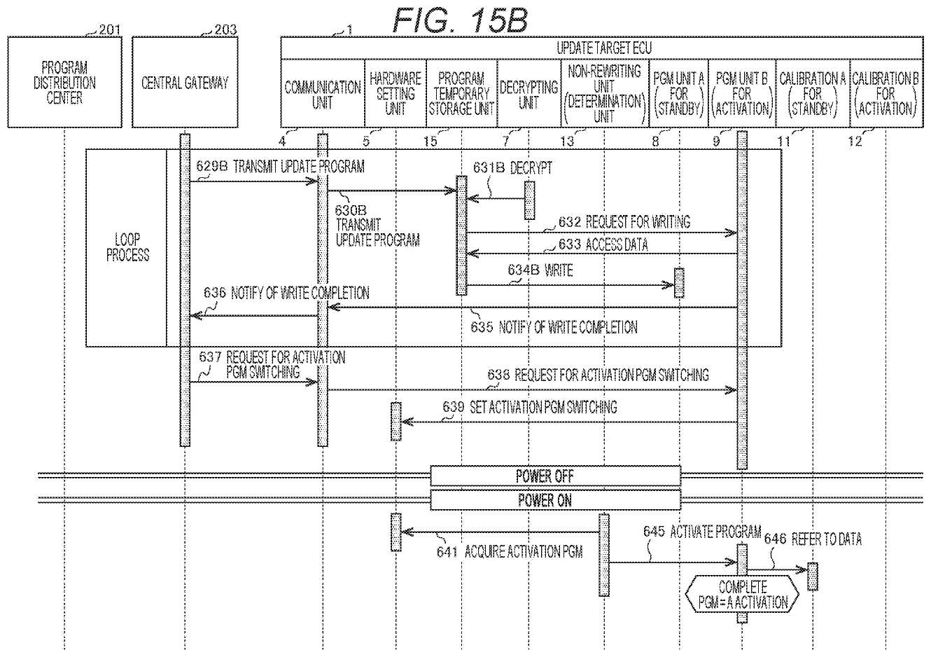

In the eighth embodiment, the example in which the vehicle control device 1 performs collation with the control target information has been described. However, in the present embodiment, an example in which the update program is collated with the system configuration information before the power is turned off will be described with reference to FIGS. 15A and 15B. FIG. 15A illustrates a case where the collation result of the system configuration information is valid in a first half of the time chart illustrating an example of the process performed by the control system. FIG. 15B is a latter half of the time chart.

Upon receiving the power supply (power ON) from the power supply device 16, the vehicle control device 1 activates the determination unit 13 of the non-rewriting unit 20. The processes from acquisition (621) to decrypting (630A) of the activation program are similar to the processes in the eighth embodiment.

The communication unit 4 receives the ciphertext 303 that is the head in the update program including the plurality of ciphertexts 303, stores the received ciphertext in the program temporary storage region 15, and decrypts the ciphertext into the plaintext (631A). In the program temporary storage region 15, the head portion of the update program and the system configuration information are decrypted.

In step 1324, the communication unit 4 acquires the decrypted system configuration information from the program temporary storage region 15. In step 1521, the communication unit 4 communicates with a sensor 1502 to acquire configuration information of the sensor. In step 1522, the communication unit 4 communicates with a camera 1501 to acquire configuration information of the camera.

The communication unit 4 collates the system configuration information acquired from the program temporary storage region 15 with the pieces of configuration information of the sensor and the camera. In this collation, as will be described later with reference to FIG. 18, information indicating the configuration of the control system is added to the header of the update program, and it is determined whether the information matches the pieces of configuration information (number) of the sensor and the camera acquired by the communication unit 4. When the number of sensors and cameras matches the system configuration information given to the update program, the collation result is valid.

When the collation result of step 1325 is valid, the communication unit 4 starts the write process. When the collation result is valid, the communication unit 4 writes the decrypted update program that is the head from the program temporary storage region 15 to the program unit A (8) (634A). The communication unit 4 requests the central gateway 203 to transmit the second and subsequent ciphertexts 303 (628B).

Subsequently, a loop process of steps 629B to 636 illustrated in FIG. 15B is performed similarly to the eighth embodiment described above. After the writing of the distributed update program is ended, a request to switch the activation program unit in step 637 is transmitted from the central gateway 203 to the program unit B (9) via the communication unit 4 (638).

The program unit B (9) switches information on the program unit for activation set in the hardware setting unit 5. In the present embodiment, the program unit for activation is switched to the program unit A (8).

At the time of the next activation, the determination unit 13 acquires the program unit for activation in step 641, the determination unit 13 activates the program of the program unit A (8) in step 645, and the program unit A (8) starts the control of the control target device 50 while referring to the data of the calibration unit A (11) in step 646.

In the first embodiment, before the program unit A (8) is activated in step 645, the determination unit 13 performs the processes from the acquisition of the control target information in step 642 to the collation in step 644 illustrated in FIG. 5B. On the other hand, in the present embodiment, since the collation of the system configuration information is performed immediately after the decrypting (631A), the collation after the reactivation may not be performed.

As described above, the vehicle control device 1 of the ninth embodiment performs the collation at a stage immediately after the ciphertext 303 that is the head is decrypted and before the ciphertext is written in the program unit A (8). As a result, the vehicle control device 1 can prevent the update program including an error from being written to the nonvolatile memory 6, and can improve the reliability of the update process of the program (reprogramming).

### Tenth Embodiment

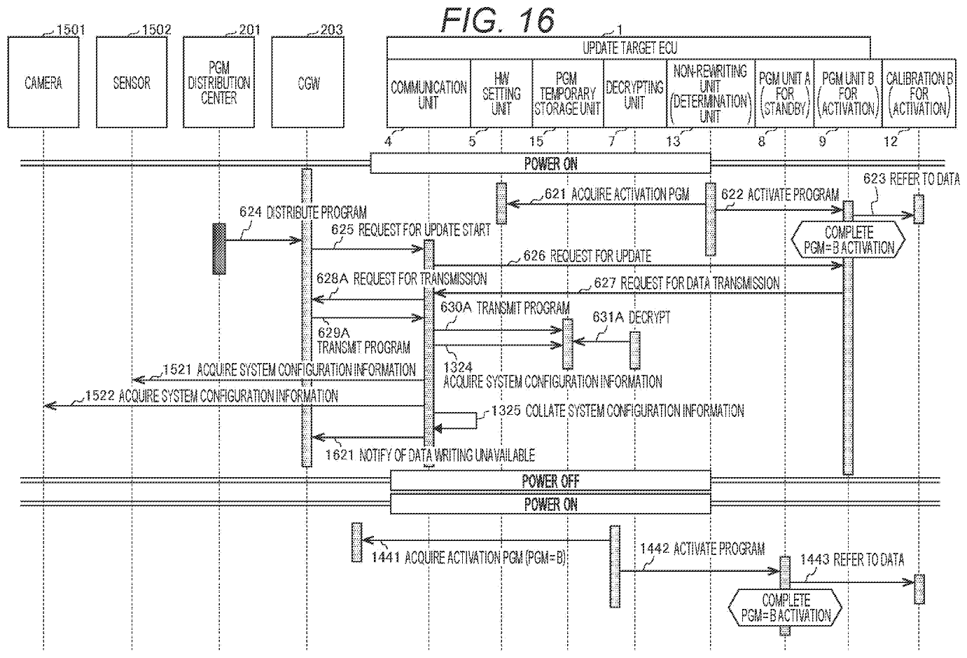

As in to the ninth embodiment, in a tenth embodiment, the collation of the system configuration information is performed before the vehicle control device 1 is turned off, and the process when the collation result is invalid will be described with reference to FIG. 16.

Upon receiving the power supply (power ON) from the power supply device 16, the vehicle control device 1 activates the determination unit 13 of the non-rewriting unit 20. The processes from the acquisition of the activation program in step 621 to the collation of the system configuration information in step 1325 are similar to the processes in the above-described ninth embodiment.

When the collation in step 1325 is invalid, the communication unit 4 notifies the central gateway 602 of a data write unavailable notification from the communication unit 4. When the collation result is invalid, the vehicle control device 1 does not write the transmitted update program in the program unit A (8).

Since the vehicle control device 1 does not change the setting of the hardware setting unit 5, the vehicle control device is activated by the same program unit B (9) as the previous program unit at the time of the next activation.

As a result, the vehicle control device 1 can prevent the update program including an error from being written to the nonvolatile memory 6, and can improve the reliability of the update process of the program (reprogramming).

### Eleventh Embodiment

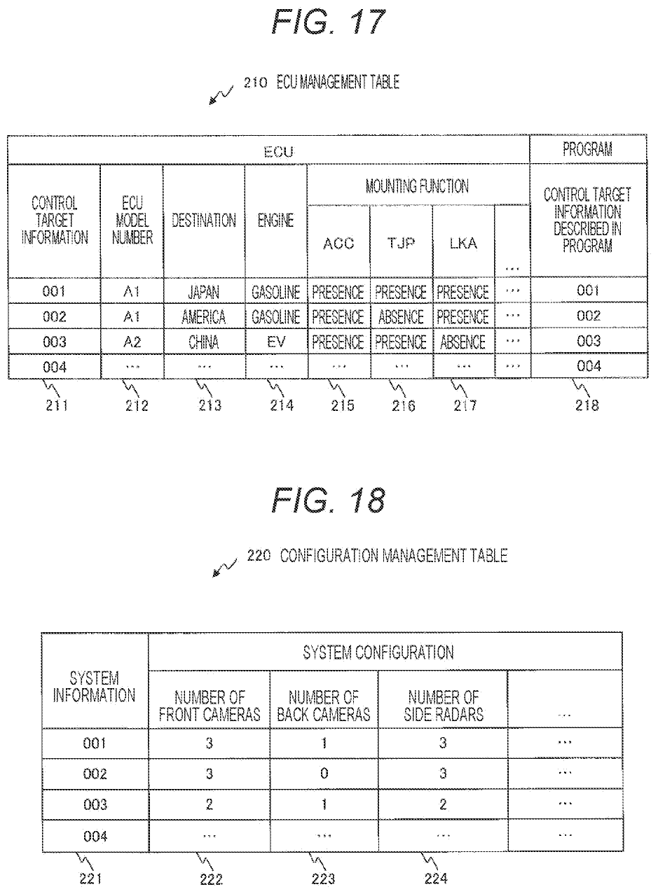

The collation targets in the first embodiment to the fifth embodiment and the eighth and ninth embodiments are examples using the control target information. The control target information is set in the non-rewriting unit 20 at a timing when the vehicle control device 1 is shipped from the factory. Examples of the control target information and the control target information stored in the program will be described with reference to FIG. 17.

FIG. 17 is a diagram illustrating an example of an ECU management table 210. In the present embodiment, an example in which the ECU management table 210 is managed by the program distribution center 201 will be described. The ECU management table 210 includes the control target information 211, an ECU model number 212, a destination 213, an engine 214, a field group (215 to 217) indicating presence or absence of a mounting function, and control target information 218 described in the program in one entry.

The control target information 211 stores an identifier of the vehicle control device 1. The ECU model number 212 stores a model of the vehicle control device 1. The destination 213 stores a sales region of the vehicle having the vehicle control device 1 mounted thereon. A type of a power source of the vehicle is stored in the engine 214.

The presence or absence of the function given to the vehicle control device 1 is set as the mounting function, and in the illustrated example, the presence or absence of functions of adaptive cruise control (ACC) 215, traffic jam pilot (TJP) 216, and lane keeping assist (LKA) 217 is illustrated.

The control target information 218 stores the identifier of the vehicle control device 1 described in the program and the calibration data distributed from the program distribution center 201.

When shipping the vehicle control device 1 in which the ECU model number 212 is “A1”, the destination 213 is “Japan”, the engine 214 is “gasoline”, the ACC 215 is “presence”, the TJP 216 is “presence”, and the LKA 217 is “presence” among the mounting functions, the control target information 211=“001” is stored in the non-rewriting unit 20.

When there is a change in the program or the calibration data with respect to the vehicle control device 1 with the control target information 211=“001”, “001” is stored in head data of the program, and the program is distributed from the program distribution center 201.

In the collation of step 644 in FIG. 5B described in the first embodiment, the determination unit 13 collates the control target information “001” stored in the non-rewriting unit 20 with the control target information “001” stored in the head data of the update program.

The determination unit 13 activates the program unit A (8) when the pieces of control target information match each other (649), and does not activate the program unit A (8) in which the update program is written and activates the program unit B (9) activated before the power supply is cut off when the pieces of control target information do not match each other. The activation of the program unit A (8) waits until the next program is transmitted from the central gateway 203 and is written correctly.

As described above, the control target information can be collated with the control target information of the non-rewriting unit 20 of the vehicle control device 1 by describing the control target information for identifying the vehicle control device 1 in the update program, and the validity of the update program can be determined.

### Twelfth Embodiment

The collation target in the sixth, seventh, ninth, and tenth embodiments is the system configuration information. The system configuration information is stored in the data storage region 10 of the rewriting unit 30 at a timing when the vehicle control device 1 is shipped from the factory. Examples of the system configuration information and the system information stored in the program will be described with reference to FIG. 18.

FIG. 18 is a diagram illustrating an example of a configuration management table 220. In the present embodiment, an example in which the configuration management table 220 is managed by the program distribution center 201 will be described. The configuration management table 220 includes, in one entry, system information 221 and system configurations (222 to 224) that stores the type and number of devices constituting the control system of the vehicle.

The system information 221 stores an identifier for identifying the component of the control system of the vehicle. In the illustrated example, the system configuration includes the number of front cameras 222 for monitoring the front of the vehicle, the number of back cameras 223 for monitoring the rear, and the number of side radars 224 for monitoring the side.

The illustrated vehicle with system information 221=“001” is a control system for a vehicle having three front cameras, one back camera, and three side radars mounted thereon.

When the vehicle control device 1 is shipped, the system information=“001” is stored in the data storage region 10. For the system information 221=“001”, when there is a change in the program or the calibration data, “001” is stored in the head data of the program, and the update program is distributed from the program distribution center 201.

In the collation process of step 1043 in FIG. 10 of the sixth embodiment, the determination unit 13 collates the system information=“001” stored in the data storage region 10 with the system information=“001” stored in the head data of the program.

The determination unit 13 activates the program unit A (8) designated by the hardware setting unit 5 when the pieces of system information match, and does not activate the program designated by the hardware setting unit 5 and activates the program unit B (9) activated previously when the pieces of system information do not match. The activation of the program unit A (8) waits until the next update program is transmitted from the central gateway 203 and is correctly written in the rewriting unit 30.

In the present embodiment, the determination unit 13 can determine the validity of the update program by reading the system information stored in the rewritable data storage region 10 and collating the system information with the system information described in the update program.

It is not necessary to store the information in the non-rewriting unit 20 at the time of factory shipment by setting the system information in the rewritable data storage region 10, and the collation can be performed even when the control target information stored in the non-rewriting unit 20 cannot be collated.

### Thirteenth Embodiment

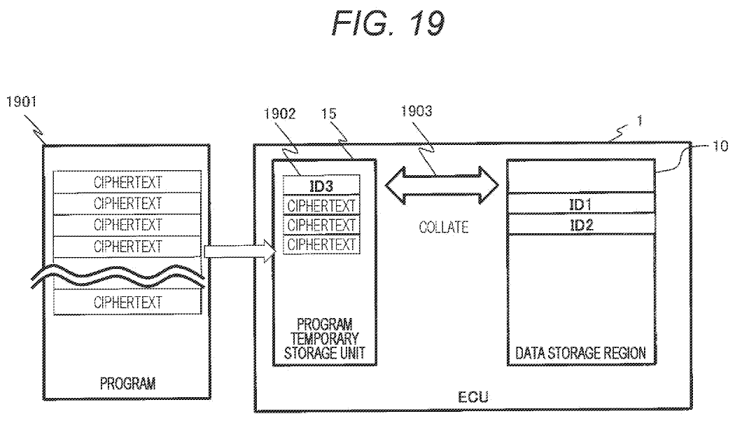

In a thirteenth embodiment, an example of the collation process will be described with reference to FIG. 19. FIG. 19 is a diagram illustrating an example of the collation process of the system information stored in the data storage region 10.

Reference sign 1901 in FIG. 19 denotes an encrypted update program, and the vehicle control device 1 stores the update program in the program temporary storage region 15 after decrypting the update program. An identifier (version information) 1902 of the update program is stored in head data of the program 1901, and the illustrated example is “ID3”.

In the collation process 1903 in the drawing, when a value of an ID of the identifier (ID2) 1902 stored in the decrypted update program is larger than a maximum value (ID2) of values of identifiers of the update programs stored in the data storage region 10, the determination unit 13 permits writing.

In this case, it is assumed that the identifier of the update program in the data storage region 10 is updated whenever the update is performed. That is. The determination unit 13 stores the identifier 1902 (ID3) of the update program in the data storage region 10. By this process, when the data of the distributed update program is an old version, writing is not performed.

As described above, the program distribution center 201 increases and gives the value of the identifier of the update program when the update program is distributed, and the vehicle control device 1 prevents an old version of the update program from being written by prohibiting the writing of the update program when the value of the identifier of the received update program is equal to or less than the value of the identifier of the data storage region 10.

### CONCLUSION

As described above, the vehicle control device 1 of the above embodiments can have the following configuration.

(1) A vehicle control device (1) includes a calculation unit (3) and a memory (nonvolatile memory 6 or volatile memory 14), and updates software (ciphertext 303) stored in the memory (6). The vehicle control device includes a communication unit (4) which receives encrypted software (303), a decrypting unit (7) which decrypts the encrypted software (303) into a plaintext (312), a rewriting unit (20) which is set in the memory (6) and stores the decrypted software, and a determination unit (13) which collates first collation information (control target information 211) set in advance in the memory (6), second collation information (identifier 1902 or control target information 218) given to the software (303), and the first collation information (211), determines whether or not to store the decrypted software (plaintext 312) based on a collation result, and selects the decrypted software (312) as software for next activation when the decrypted software (312) is stored.

With the above configuration, the determination unit 13 determines whether the program to be activated is valid software by verifying that the control target information (218) described in the activation program unit A (8) matches the control target information (211) at the time of factory shipment set in the non-rewriting unit 20. The reliability of the update process of the program (reprogramming) in the vehicle control device 1 can be improved by determining the validity of the program (software) executed by the determination unit 13.

(2) In the vehicle control device according to (1), the software (303) includes at least one of a program and calibration data for adjusting an output of the program, the rewriting unit (20) independently has a first program unit (program unit B9) which stores the program for activation, a first calibration unit (calibration unit B12) which stores calibration data for the activation, a second program unit (program unit A8) which stores the program for update, and a second calibration unit (calibration unit A11) which stores calibration data for the update, and the determination unit (13) stores the decrypted program (312) in the second program unit (8), and stores the decrypted calibration data (312) in the second calibration unit (11).

With the above configuration, when the collation result of the control target information (211 or 218) mismatches (is invalid), the determination unit 13 can improve the reliability of the update process of the program (reprogramming) in the vehicle control device 1 by prohibiting the activation with the update program. In other words, when the collation result is invalid, the switching between the program unit A (8) for activation and the program unit B (9) for standby is prohibited, and thus, it is possible to reliably prevent the vehicle from being controlled by an invalid program.

(3) In the vehicle control device according to (1), the memory (6 or 14) includes a nonvolatile memory (6), and the nonvolatile memory (6) has a non-rewriting unit (20) which stores the first collation information (211).

With the above configuration, the non-rewriting unit (20) holds the collation information (control target information 211), and thus, falsification of the collation information can be prevented.

(4) In the vehicle control device according to (1), the memory (6 or 14) includes a nonvolatile memory (6), and the rewriting unit (20) is set in the nonvolatile memory (6), the rewriting unit (20) has a data storage region (10) which stores system configuration information (system information 221) of a vehicle as the first collation information, the system configuration information (222 to 224) of the vehicle is set as the second collation information, and the determination unit (13) collates the system configuration information (221) of the data storage region (10) with the system configuration information (222) given to the software (303).

With the above configuration, the determination unit collates the validity of the update program with the system configuration information stored in the data storage region 10 of the nonvolatile memory 6. The system configuration information does not need to be stored in the non-rewriting unit 20 at the time of factory shipment, and the collation can be performed even when the collation cannot be performed with the control target information stored in the non-rewriting unit 20. When the collation result is invalid, the determination unit 13 can reliably prevent the vehicle from being controlled by an invalid program by prohibiting the switching of the activation program.

(5) In the vehicle control device according to (4), the data storage region (10) is rewritable from a diagnosis device (1201) connected to the vehicle control device (1).

With the above configuration, as described above, the system configuration information stored in the vehicle control device 1 is also rewritable from the external diagnosis device 1201. Since the system configuration information can be rewritten from the external diagnosis device 1201, the same collation can be performed even when a user of the vehicle optionally changes the components of the control system such as a sensor and a camera or the collation cannot be performed with the control target information written at the time of factory shipment.

(6) In the vehicle control device according to (2), the determination unit (13) switches the second program unit (8) to a program unit for activation and switches the first program unit (program unit B9) to a program unit for update when the collation result is valid, and prohibits the switching between the program unit for activation and the program unit for update when the collation result is invalid.

With the above configuration, when the collation result is invalid, the determination unit 13 can reliably prevent the vehicle from being controlled by an invalid program by prohibiting the switching of the activation program.

(7) In the vehicle control device according to (1), the communication unit (4) receives a plurality of the pieces of divided software (303), and the determination unit (13) acquires second collation information (218) included in a first received portion among the pieces of divided software (303), and collates the acquired second collation information with the first collation information (211).

With the above configuration, since the determination unit 13 collates the pieces of control target information (211 and 218) before writing the decrypted update program in the rewriting unit 30, it is possible to improve the reliability of the update process of the program (reprogramming) in the vehicle control device 1 as in the first embodiment.

The present invention is not limited to the aforementioned embodiments, and includes various modification examples.

For example, the aforementioned embodiments are described in detail in order to facilitate easy understanding of the present invention, and are not limited to necessarily include all the described components. Furthermore, some of the components of a certain embodiment can be substituted into the components of another embodiment, and the components of another embodiment can be added to the component of a certain embodiment. For a part of the configurations of the embodiments, any addition, deletion, or substitution of other configurations can be applied alone or in combination.

Furthermore, a part or all of the aforementioned configurations, functions, processing units, and processing means may be realized by hardware by being designed with an integrated circuit, for example. Each of the aforementioned configurations and functions may be realized by software by interpreting and executing a program that realizes each function by the processor. Information of programs, tables, and files for realizing the functions can be stored in a recording device such as a memory, a hard disk, or a solid state drive (SSD), or a recording medium such as an IC card, an SD card, or a DVD.

Furthermore, control lines and information lines illustrated are considered to be necessary for the description, and not all the control lines and information lines in a product are necessarily illustrated. Almost all the configurations may be considered to be actually connected to each other.

### REFERENCE SIGNS LIST

1 vehicle control device
2 power supply
3 calculation unit
4 communication unit
5 hardware setting unit (UCB)
6 nonvolatile memory
7 decrypting unit
8 program unit A
9 program unit B
9 data storage region inside nonvolatile memory
10 data storage region
11 calibration unit A
12 calibration unit B
13 determination unit
14 volatile memory
15 program temporary storage unit
16 power supply device
17 external device
20 non-rewriting unit
30 rewriting unit
201 program distribution center
202 antenna ECU
203 central gateway

1. A vehicle control device which includes a calculation unit and a memory, and updates software stored in the memory, the vehicle control device comprising:
a communication unit which receives encrypted software;
a decrypting unit which decrypts the encrypted software into a plaintext;
a rewriting unit which is set in the memory and stores the decrypted software; and
a determination unit which collates first collation information set in advance in the memory, second collation information given to the software, and the first collation information, determines whether or not to store the decrypted software based on a collation result, and selects the decrypted software as software for next activation when the decrypted software is stored.

2. The vehicle control device according to claim 1, wherein
the software includes at least one of a program and calibration data for adjusting an output of the program,
the rewriting unit independently has a first program unit which stores the program for activation, a first calibration unit which stores calibration data for the activation, a second program unit which stores the program for update, and a second calibration unit which stores calibration data for the update, and
the determination unit stores the decrypted program in the second program unit, and stores the decrypted calibration data in the second calibration unit.

3. The vehicle control device according to claim 1, wherein
the memory includes a nonvolatile memory, and
the nonvolatile memory has a non-rewriting unit which stores the first collation information.

4. The vehicle control device according to claim 1, wherein
the memory includes a nonvolatile memory, and the rewriting unit is set in the nonvolatile memory,
the rewriting unit has a data storage region which stores system configuration information of a vehicle as the first collation information,
the system configuration information of the vehicle is set as the second collation information, and
the determination unit collates the system configuration information of the data storage region with the system configuration information given to the software.

5. The vehicle control device according to claim 4, wherein the data storage region is rewritable from a diagnosis device connected to the vehicle control device.

6. The vehicle control device according to claim 2, wherein the determination unit switches the second program unit to a program unit for activation and switches the first program unit to a program unit for update when the collation result is valid, and prohibits the switching between the program unit for activation and the program unit for update when the collation result is invalid.

7. The vehicle control device according to claim 1, wherein
the communication unit receives a plurality of the pieces of divided software, and
the determination unit acquires second collation information included in a first received portion among the pieces of divided software, and collates the acquired second collation information with the first collation information.

8. A vehicle control system comprising:
a wireless communication unit which receives software by wireless communication;
a relay device which distributes the software received by the wireless communication unit; and
a vehicle control device which has a calculation unit and a memory and updates the software,
wherein the vehicle control device includes
a communication unit which receives encrypted software,
a decrypting unit which decrypts the encrypted software into a plaintext,
a rewriting unit which is set in the memory, and stores the decrypted software, and
a determination unit which collates first collation information set in advance in the memory, second collation information given to the software, and the first collation information, determines whether or not to store the decrypted software based on a collation result, and selects the decrypted software as software for next activation when the decrypted software is stored.

9. The vehicle control system according to claim 8, wherein
the software includes at least one of a program and calibration data for adjusting an output of the program,
the rewriting unit independently has a first program unit which stores the program for activation, a first calibration unit which stores calibration data for activation, a second program unit which stores the program for update, and a second calibration unit which stores calibration data for the update, and
the determination unit stores the decrypted program in the second program unit, and stores the decrypted calibration data in the second calibration unit.

10. The vehicle control system according to claim 8, wherein
the memory includes a nonvolatile memory, and
the nonvolatile memory has a non-rewriting unit which stores the first collation information.

11. The vehicle control system according to claim 8, wherein
the memory includes a nonvolatile memory, and the rewriting unit is set in the nonvolatile memory,
the rewriting unit has a data storage region which stores system configuration information of a vehicle as the first collation information,
the system configuration information of the vehicle is set as the second collation information, and
the determination unit collates the system configuration information of the data storage region with the system configuration information given to the software.

12. The vehicle control system according to claim 11, wherein the data storage region is rewritable from a diagnosis device connected to the vehicle control system.

13. The vehicle control system according to claim 9, wherein the determination unit switches the second program unit to a program unit for activation and switches the first program unit to a program unit for update when the collation result is valid, and prohibits the switching between the program unit for activation and the program unit for update when the collation result is invalid.

14. The vehicle control system according to claim 8, wherein
the communication unit receives a plurality of the pieces of divided software, and
the determination unit acquires second collation information included in a first received portion among the pieces of divided software, and collates the acquired second collation information with the first collation information.
